(19) United States
(12) Patent Application Publication
(10) Pub. No.: US 2007/0199955 A1
(43) Pub. Date: Aug. 30, 2007

(54) Dispensing container for two flowable products

(76) Inventors: Stephen E. Stalions, Ft. Wayne, IN (US); Richard A. Laveault, Ft. Wayne, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/362,940

(22) Filed: Feb. 27, 2006

(51) Int. Cl. B65D 35/56; B67D 5/56; A47G 19/14

(52) U.S. Cl. 222/129; 222/465.1; 222/105

(57) ABSTRACT

A dispensing container for two flowable products includes a first container arranged for receipt of a first flowable product and having a first dispensing outlet, a second container positioned within the first container and arranged for receipt of a second flowable product, the second container including a second dispensing outlet. A closure assembly including a closure fitrnent, a closing plug, and a threaded cap is constructed and arranged to be assembled to the first and second containers. The closure fitment snaps into the first dispensing outlet and includes a first fitment outlet for one product and a second fitment outlet for the other product. The threaded cap engages the closure fitment and, as the threaded cap moves axially, the closing plug moves axially therewith. The closing plug includes plug members to insert into the fitment outlets to close off those fitment outlets.

### BACKGROUND OF THE INVENTION

The present invention relates in general to dispensing containers that include a container body, a closure connected into an outlet of the container body, and a closing cap assembled to the closure. More specifically, the present invention relates to a dispensing container that is constructed and arranged to separately contain two flowable products and to separately dispensing those two flowable products, although concurrently, so that the two flowable products are allowed to mix only after being dispensed (i.e., co-dispensing). Structural features and relationships disclosed by various embodiments of the present invention enable the two flowable products to be co-dispensed in a particular ratio. Some of the needs for this type of proportionate dispensing are described in U.S. Pat. No. 4,678,103, issued Jul. 7, 1987 to Dirksing.

As stated in the '103 patent, many chemical systems require two or more components to be kept separate before they are mixed and used in order to achieve certain desired properties. Such systems include epoxy adhesives, detergent and bleach combinations, detergent and fabric softener combinations, beverages, and foodstuffs, to list some of the possibilities. In such systems, it is usually important for the relative proportions of the components to remain within certain limits to achieve optimal results. In the preferred embodiment, the two products are a clear coat material and a lacquer thinner. These two products need to be mixed in order to achieve the desired viscosity for use in a spray paint gun or equipment.

When different amounts of such multi-component systems are needed, it has been generally necessary to first weigh-measure or volume-measure the components separately and then mix them by hand. In addition to being time consuming and messy, such systems are impractical because weighing or measuring devices are typically not available at the place where such multi-component systems are to be applied. Few households, for example, have measuring devices that permit proper proportioning of components in small quantities, and estimating proportions by eye is not only difficult, but risks failure in achieving the proper proportions and the corresponding optimal characteristics of the chemical system.

Related benefits of the disclosed embodiment of the present invention include the ability to provide everything in a single package and the elimination of any particular skill level to be able to measure out the two products in the right ratio. From a marketing perspective, the two-product combination in a single package ensures that both products will be purchased from the same manufacturer. When one of the two products is a common composition and not proprietary, it could be obtained from other sources, but for this two-product, pre-packaged combination.

There have been many attempts to provide plural-chambered dispensing devices that co-dispense two or more flowable products. However, in trying to maintain a constant pouring or dispensing ratio between the poured products, most of these devices require complex and expensive features which make the devices difficult and impractical to manufacture. In addition, the particular structures of these devices usually do not provide the degree of metering accuracy necessary for certain co-dispensing applications.

The '103 patent elected to address this design challenge by first placing an inner container within an outer container for the two flowable products and then placing a third, empty container inside of the inner container. The intent was to try and use the empty container to affect the pouring characteristics of the inner container in the same way that the inner container would presumably affect the pouring characteristics of the outer container.

In addition to the obvious inefficiencies of fabricating and installing a third, empty container, its size causes an increase in the overall size of the inner container and/or a reduction of the volume of product contained therein. As the inner container increases in size, so as to handle the desired volume of product, the outer container must correspondingly increase in size.

The present invention approaches this challenge of precisely and reliably co-dispensing dispensing two flowable products by focusing on the design of the container closure and on the design of any cooperating venting structures. This approach is considered to be more controllable with more accurate co-dispensing. This approach also permits greater design versatility in that different closure characteristics can be used to influence the proportions of the two flowable products without needing to change the size or shape of the inner and outer containers, but a change to the containers can be made, if desired. In one embodiment of the present invention, merely changing the fitment and the corresponding closing plugs allows the dispensing ratio to be changed in that the product dispensing ratio is dependent on the cross sectional flow area of the two flowable product dispensing outlets.

As will be described herein and as illustrated in the accompanying drawings, the present invention, as disclosed and claimed, provides a novel and unobvious advance in the state of the art for dispensing containers.

### BRIEF SUMMARY OF THE INVENTION

A dispensing container for two flowable products, according to one embodiment of the present invention, comprises a first container constructed and arranged for receipt of a first flowable product, a second container constructed and arranged for receipt of a second flowable product, a closure fitment assembled to the first container, and a closure subassembly threadedly engageable with the closure fitment. The first container includes a first dispensing outlet and defines a hollow interior. The second container includes a second dispensing outlet and is positioned within the hollow interior of the first container. The closure fitment defines a first fitment outlet for dispensing the first flowable product and a second fitment outlet for dispensing the second flowable product. The closure assembly includes a closing plug and a threaded cap wherein the threaded cap is threadedly attached to the fitment and wherein the closing plug includes a first plug member for closing off the first fitment outlet and a second plug member for closing off the second fitment outlet. The respective cross sectional flow areas of the first and second fitment outlets determine the dispensing ratio of the first and second flowable products.

One object of the present invention is to provide an improved dispensing container for two flowable products.

Related objects and advantages of the present invention will be apparent from the following description.

### BRIEF DESCRIPTION OF THE SEVERAL VIEWS OF THE DRAWINGS

FIG. 1 is a front elevational view of a dispensing container for two flowable products, according to a typical embodiment of the present invention.

FIG. 2 is an end elevational view of the FIG. 1 dispensing container.

FIG. 3 is a top plan view of the FIG. 1 dispensing container.

FIG. 4 is a partial, end elevational view, in full section, of the FIG. 1 dispensing container.

FIG. 5 is a front elevational view of a fitment comprising one component of the FIG. 1 dispensing container.

FIG. 6 is a perspective view of the FIG. 5 fitment.

FIG. 7 is a bottom plan view of the FIG. 5 fitment.

FIG. 8 is a front elevational view, in full section, of the FIG. 5 fitment.

FIG. 9 is a front elevational view of a closing plug comprising one component of the FIG. 1 dispensing container.

FIG. 10 is a perspective view of the FIG. 9 closing plug.

FIG. 11 is a bottom plan view of the FIG. 9 closing plug.

FIG. 12 is a front elevational view, in full section, of the FIG. 9 closing plug.

FIG. 13 is a front elevational view of a threaded cap comprising one component of the FIG. 1 dispensing container.

FIG. 14 is a perspective view of the FIG. 13 threaded cap.

FIG. 15 is a front elevational view, in full section, of the FIG. 13 threaded cap.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

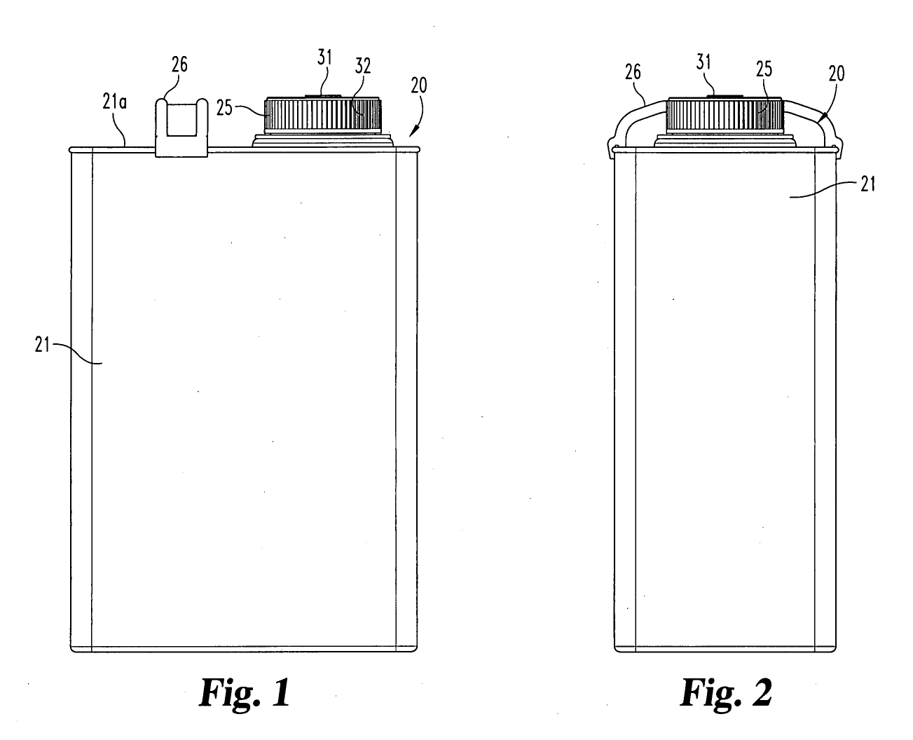

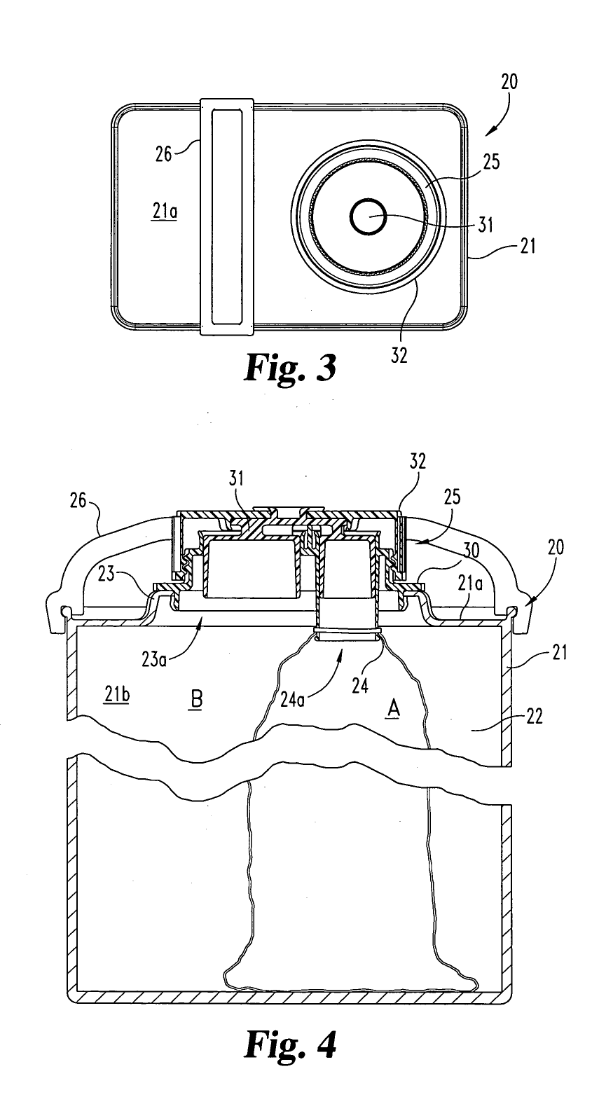

Referring to FIGS. 1-4, there is illustrated a dispensing container 20 for two flowable products A and B. Included as part of dispensing container 20 is an outer container 21 for product A and an inner container 22 for product B. While the size, shape, and material of containers 21 and 22 may vary, consistent with the teachings of the present invention, a metal can-type container with six generally rectangular sides or panels is preferred for outer container 21. To be more precise, container 21 includes four sidewalls, a closed base panel, and an upper panel 21a that defines an outlet 23 with an outlet opening 23a. A plastic bag or plastic pouch-type container having a collapsible body is preferred for inner container 22. The ability of a plastic bag to collapse onto itself as the product is dispensed, means that the dispensing flow is smooth and continuous without glugging and without the need for a vent tube or vent path. By designing the inner container 22 in this manner, it is possible to collapse the body of this plastic bag or pouch and thereby be able to insert container 22 into outer container 21 after container 21 is fabricated. If a rigid or a semi-rigid container would be selected for inner container 22, then assembly into container 21 would require a larger opening. The most likely approach would be to install container 22 prior to seaming upper panel 21a onto the four sidewalls. With a rigid or semi-rigid inner container 22, venting needs to be considered if “glugging” is unacceptable.

Container 22 defines an outlet 24 with an outlet opening 24a. The positioning of container 22 within container 21 is such that opening 24a is aligned with opening 23a (see FIG. 4). The container assembly identified herein as dispensing container 20, includes outer container 21, inner container 22, a snap-on handle 26, and is completed by a closure assembly 25 that includes a snap-in closure fitment 30, a closing plug 31, and an outer threaded cap 32. Snap-on plastic handle 26 is an optional, though preferred, accessory. Due to the fact that closing plug 31 and outer threaded cap 32 are preferably snapped together prior to threaded engagement onto fitment 30, the assembly of these two parts (closing plug 31 and outer threaded cap 32) is described herein as being a closure subassembly that is threadedly engageable with the closure fitment.

In terms of the assembly of inner container 22 into outer container 21, when container 22 is a flexible plastic bag or pouch, the first step is to present container 22 in an empty, collapsed condition so that its overall physical size is collapsed or compressed to a minimum. As will be described in greater detail herein, the outlet of container 22 is securely connected to a conduit that is unitarily molded as part of fitment 30. As this fitment is snapped onto (into) outlet 23 of container 21, the inner container 22 is positioned within the hollow interior 21b of outer container 21. Then, as the inner container is filled with product, the flexibility of the plastic material used for container 22 allows it to open and expand or enlarge to the extent necessary based upon the amount or volume of product B being filled into container 22.

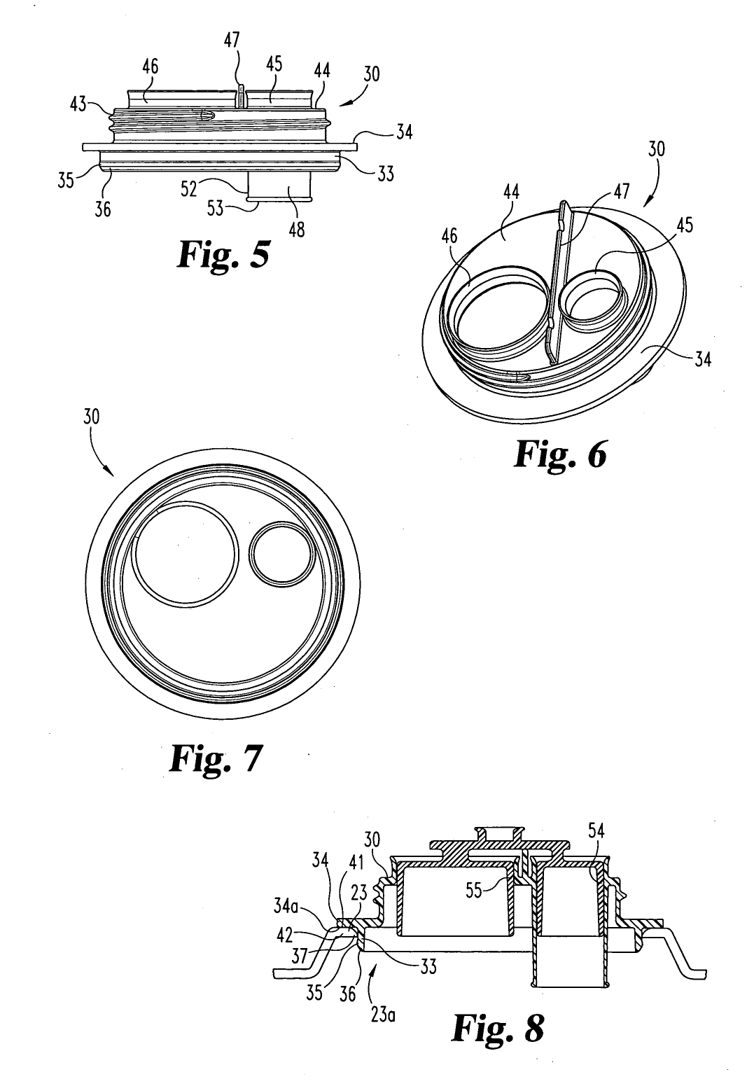

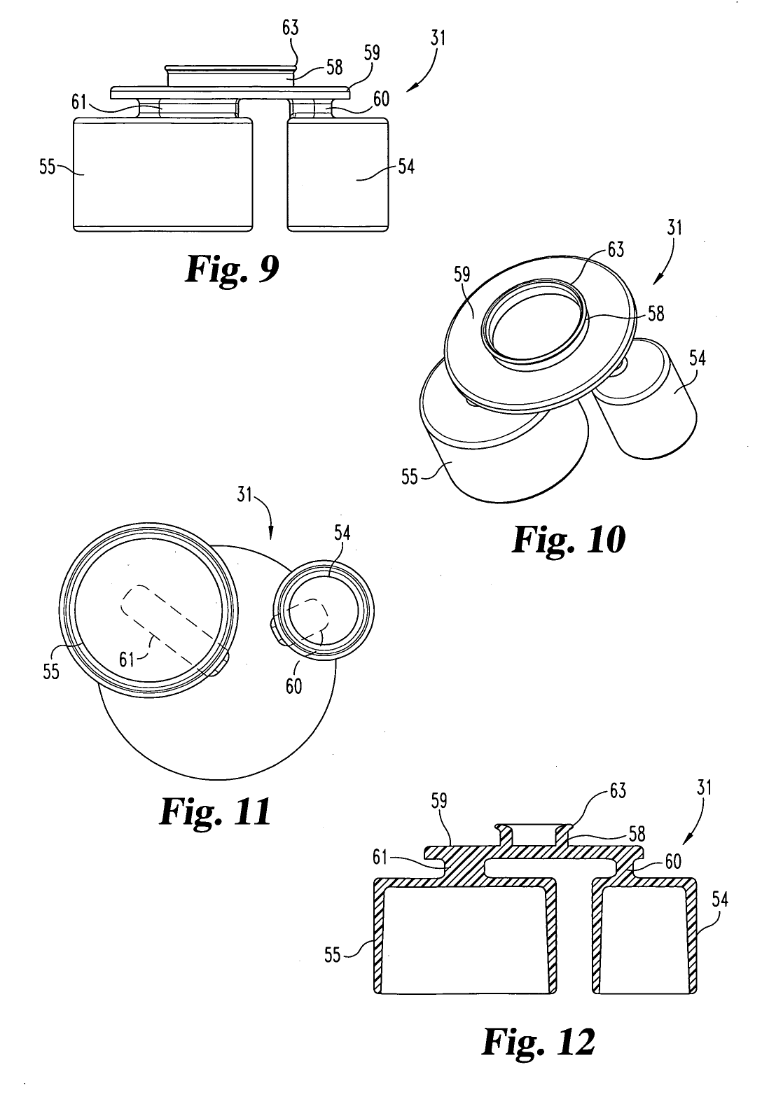

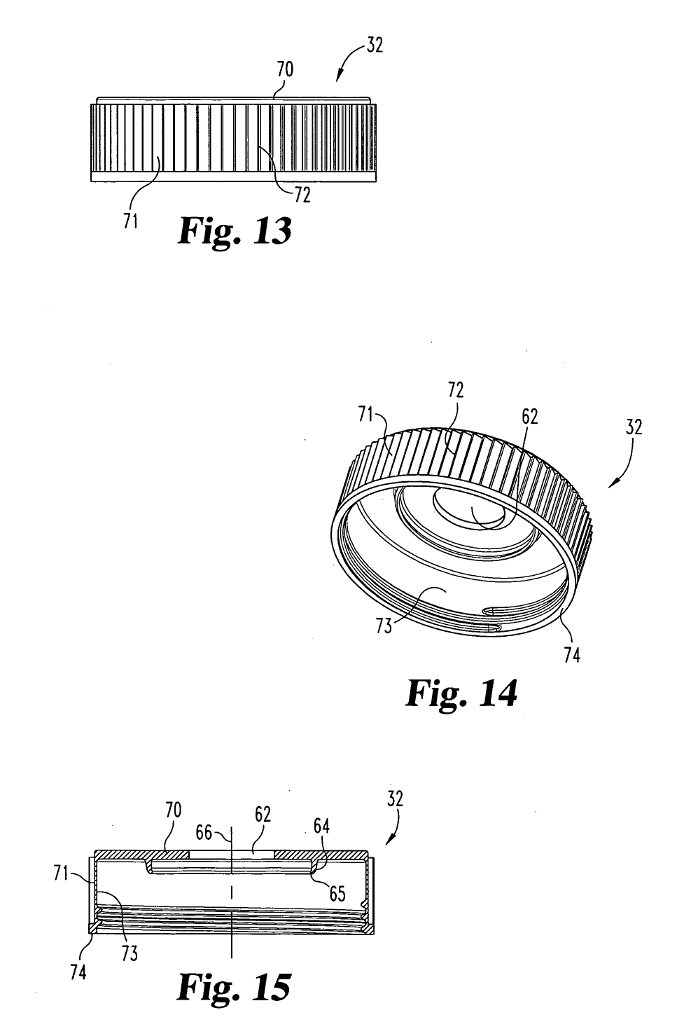

The details of closure assembly 25 are illustrated in FIGS. 4-15. From these drawing illustrations, it will be seen that closure 25, as noted above, includes three cooperating parts that work with each other to manage and control the dispensing of products A and B from containers 22 and 21, respectively. In terms of the three component parts that cooperate with one another in order to create closure 25, the configuration and structural details of fitment 30 are further illustrated in FIGS. 5-8. The configuration and structural details of closing plug 31 are further illustrated in FIGS. 9-12. The configuration and structural details of outer threaded cap 32 are further illustrated in FIGS. 13-15.

Referring now to FIGS. 4-8, fitment 30 is a unitary, injection molded plastic part that is preferably fabricated out of polypropylene. Fitment 30 includes an annular wall 33 extending away from radial flange 34. An annular raised rib 35 adjacent lower edge 36 provides part of the snap-in retention for fitment 30 into outlet 23 of outer container 21. Annular wall 33 is constructed and arranged to insert into outlet opening 23a while rib 35 cooperates with the lower edge 37 of outlet 23 to provide the snap-in assembly and retention of fitment 30 into the opening 23a of outlet 23. Lower edge 36 is tapered in order to facilitate the insertion of fitment 30 into container 21. Although described as a “snap-in” assembly due to the fact that rib 35 has to be forced past edge 37, the actual fit between outlet 23 and annular wall 33 is an interference press-fit to ensure a secure and tight (and leak-free) assembly of fitment 30 into container 21. When the connection between fitment 30 and container 21 (i.e., outlet 23) is intended to be permanent, an adhesive bonding material can be used. If container 21 is fabricated out of plastic, then a spin weld technique is preferably used to securely join these two parts with a leak-free or leak-proof interface. Fitment 30 is the only component of closure 25 that directly interfaces with either container. This allows the fitment 30 to be assembled into container 21 and for the closing plug 31 and threaded cap 32 to be pre-assembled and then, as a two-component subassembly, threaded onto the installed fitment 30.

Whether fitment 30 is assembled to container 21 with only the snap-fit technique or with the use of adhesive or with a permanent, spin-weld technique, fitment 30 remains assembled into container 21 by way of outlet 23, even if there is an attempt to pry off closure 25. This ability to remain assembled is due in part to the larger diameter across raised rib 35 as compared to the inside diameter of lower edge 37 of outlet 23. This structural feature has a greater importance when a spin-weld is not used. The generally cylindrical shape of wall 33 and the generally cylindrical shape of outlet 23 ensures that the leak-free interference fit will be maintained so long as fitment 30 remains inserted into outlet 23. When the fitment 30 is fully inserted into outlet 23, the underside surface 34a of radial flange 34 tightly presses against the upper surface 41 of outlet wall 42, thereby providing a backup or secondary sealing location.

Sidewall 43 of fitment 30 is externally threaded for threaded engagement with outer threaded cap 32. Circular upper panel 44 defines a smaller, cylindrical outlet 45 and a larger, cylindrical outlet 46. Also unitarily molded as part of upper panel 44 is a dividing bar 47 that extends between outlets 45 and 46 from one side of upper panel 44 to the opposite side, though not through the geometric center. Dividing bar 47 helps to keep products A and B separate from each other as they are co-dispensed so that any mixing only occurs as products A and B reach the mixing receptacle.

Unitarily molded as part of upper panel 44 and extending outwardly (axially downwardly) from the underside surface of panel 44 is a connecting conduit 48. Conduit 48 is generally cylindrical and has a diameter size corresponding to outlet 45. Conduit 48 is also generally coaxial or concentric with outlet 45. Accordingly, outlet 45 and conduit 48 appear as if they form a single, generally cylindrical sleeve that extends through upper panel 44. Due to the unitary molding of fitment 30, there are three integral sections, upper panel 44, outlet panel 45, and conduit 48. If not unitarily molded, then a single conduit sleeve could be inserted through the upper panel and then sealed in place and thereby create the appearance of what is now illustrated in FIGS. 4-8. The referenced sealing in place can be by an adhesive or by a spin-weld technique.

The lower end 52 of conduit 48 includes a flange 53 that securely attaches to outlet 24 of container 22 with a connection that results in a leak-free fit and sealed interface. In the preferred embodiment, container 22 is a plastic bag that is attached to flange 53. The bag is deflated and empty at the time of assembly to flange 53. In this condition, the container 22 can be easily inserted into container 21 by way of outlet 23 and opening 23a. As this insertion is occurring, the container 22 is empty. After assembly of fitment 30 into container 21, the plastic bag (container 22) is filled with product B. Then, product A is filled into the space remaining in container 21, space that is not occupied by the filled container 22. The connection of container 22 to conduit 48 preferably includes a cable tie or other flexible fastener that tightens around container 22 against conduit 48 as a back up. The enlarged size of flange 53 prevents pull off of container 22 from conduit 48. The weight of product in container 22 is supported by the base panel or, when container 21 is tilted, by a sidewall. For this to occur, container 22 needs to be large enough to extend to those support surfaces.

As will be seen from the FIG. 4 illustration, closing plug 31 includes two plug members 54 and 55 that are constructed and arranged to press into outlets 45 and 46 so as to tightly seal closed those two outlets. When the outlets 45 and 46 are open, products A and B are able to be dispensed. The closing plug 31 is free to rotate within threaded cap 32 and thus the threaded cap 32 drives the two plug members axially into the corresponding outlets in the fitment 30 to effect a seal and similarly the threaded cap 32 pulls the plug members out of the corresponding outlets to open those outlets for product A and product B dispensing.

In the illustrated embodiment, it is intended that products A and B will be dispensed concurrently in a 3:1 ratio (three parts A to one part B). This ratio is determined based upon the desired mixing ratio and it is achieved by controlling the area of the opening of outlet 45 compared to the area of the opening of outlet 46. The lateral or cross sectional flow area of outlet 46 is three times the lateral or cross sectional flow area of outlet 45. Noting that in the area equation, the radius is squared, a 3:1 ratio requires that the diameter of the larger outlet 46 be equal to the square root of 3 times the diameter of the smaller flow outlet 45, (i.e., 1.732). It thus follows that any desired mixing ratio of multiple products can be achieved by providing a dispensing outlet for each product with the proper cross sectional flow area in terms of the relative sizes.

Although a mixing ratio for products A and B has been selected as 3:1 in the preferred embodiment that is illustrated, the present invention contemplates other mixing ratios, such as a 2:1 ratio of product A to product B, a 4:1 ratio of product A to product B, and a 5:1 ratio of product A to product B. Obviously fractional ratios in between are also contemplated, noting that whatever the desired ratio might be, the respective areas have a relationship or multiples of one another equal to the square root of that particular ratio.

In the preferred embodiment illustrated in FIGS. 1-4, container 22 receives approximately 1 quart of product B that is filled into container 22 by way of smaller outlet 45. Container 21 is filled next with approximately 3 quarts of product A, by way of the larger outlet 46. Designing the larger outlet 46 with three times the dispensing area of smaller outlet 45, means that as products A and B are pouring from dispensing container 20 by the user, the user receives 3 parts of product A for every 1 part of product B. As these two products flow from the dispensing container 20, they mix with one another in this desired ratio. Due to the structural isolation of containers 21 and 22, and due to the structural isolation of outlets 45 and 46, there is no mixing nor any opportunity for any mixing of either product A into product B or product B into product A prior to the time of co-dispensing.

Referring now to FIG. 4 and FIGS. 9-12, the details of unitary closing plug 31 are illustrated. Closing plug 31 is an injection molded component fabricated out of polyethylene plastic. Considering first the axial stack of layers, as depicted in the front elevational view of FIG. 9, closing plug 31 includes a generally cylindrical top button 58, an annular radial flange 59, oblong connecting posts 60 and 61, and hollow, cylindrical plug members 54 (smaller) and 55 (larger). Oblong connecting posts 60 and 61 are set at an angle to each other that is slightly greater than 90 degrees. Their shapes and orientations explain the differences seen in the drawings in terms of widths and lengths. As a brief overview, threaded cap 32 (see FIG. 4 and FIGS. 13-15) receives and captures the top button 58 and the radial flange 59, respectively. Cap 32 includes a circular opening 62 that receives top button 58 with a snap-on clearance fit. Radial lip 63 of top button 58 has a diameter size that is slightly greater than the inside diameter of opening 62, thereby forcing some slight deformation of these component part portions as the lip 63 is forced through opening 62. Once inserted through opening 62, the larger size of lip 63 prevents push-in of the closing plug 31.

Threaded cap 32 (see FIG. 15) includes an inner, depending annular wall 64 having a radially inward tapering annular edge or lip 65 at its free end. Wall 64 is concentric with circular opening 62 about axial centerline 66. The inwardly directed lip 65 is constructed and arranged to snap onto and beneath radial flange 59. In this way, the threaded cap 32 receives, captures, and holds the closing plug 31. Threaded cap 32 is a unitary, injection molded plastic component part that is preferably fabricated out of polypropylene.

The annular clearance fit or spacing between opening 62 and top button 58 and between wall 64 and flange 59 enables relative rotation between the threaded cap 32 and closing plug 31. In other words, as the threaded cap 32 rotates (threading on and off of fitment 30), the closing plug 31 does not rotate due to these described clearances. However, the (threaded) axial movement of threaded cap 32 causes axial movement of closing plug 31, assuming sufficient axial travel of the threaded cap 32.

When it is desired to apply threaded cap 32 onto fitment 30, it is assumed that the closing plug 31 is already preassembled to the threaded cap 32 as a two-component subassembly. With this construction, the two plug members 54 and 55 are first aligned with outlets 45 and 46 and these two plug members are partially inserted into their corresponding outlets. The outwardly flared upper edges of outlets 45 and 46 facilitate this initial alignment and partial insertion. Threaded advancement of the threaded cap 32 causes the upper panel 70 to push downwardly on closing plug 31, thereby advancing closing plug 31 deeper into fitment 30. As the closing plug 31 moves axially into fitment 30, plug members 54 and 55 push deeper and tighter into outlets 45 and 46. With a slight inward draft angle, either on the outlets or on the plug members, the deeper the plug members move into the outlets, the tighter their fit. The components are constructed and arranged such that when the threaded cap is fully seated onto fitment 30, in other words full threaded engagement, the plug members 54 and 55 establish completely sealed (leak-proof) annular interfaces with each outlet 45 and 46, respectively. Dividing bar 47 can be used as an abutment stop acting against the underside surface of flange 59 in order to fix and control the depth of insertion of plug members 54 and 55 into outlet 45 and 46, respectively.

With continued reference to FIGS. 13-15, unitary threaded cap 32 includes an annular (generally cylindrical) sidewall 71 configured with a series of axial ribs 72 and an internally-threaded inner surface 73 adjacent free edge 74. The threads are constructed and arranged to mate with the external threads on fitment 30. The ribs 72 facilitate having a better grip for manual tightening and removal of threaded cap 32. As described, the threaded cap 32 and closing plug 31 are compatibly constructed and arranged to snap together into a subassembly and can remain connected together in this manner throughout the life of the closure 25.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A dispensing container for two flowable products comprising:
a first container constructed and arranged for receipt of a first flowable product and including a first dispensing outlet, said first container defining a hollow interior;
a second container constructed and arranged for receipt of a second flowable product and being positioned within said hollow interior, said second container including a second dispensing outlet;
a closure fitment assembled to said first container and defining a first fitment outlet for dispensing said first flowable product and defining a second fitment outlet for dispensing said second flowable product; and
a closure subassembly threadedly engageable with said closure fitment for closing off said first and second fitment outlets, said closure subassembly including a closing plug and a threaded cap, said threaded cap capturing a portion of said closing plug so as to axially advance said closing plug with threaded engagement of said closure subassembly onto said closure fitment and so as to axially withdraw said closing plug with threaded disengagement of said closure subassembly from said closure fitment.

2. The dispensing container of claim 1 wherein said second container is a collapsible bag.

3. The dispensing container of claim 2 wherein said closure fitment includes a dispensing conduit connected to said second dispensing outlet.

4. The dispensing container of claim 3 wherein said dispensing conduit extends from said second dispensing outlet to said second fitment outlet.

5. The dispensing container of claim 4 wherein said closing plug includes a first plug member constructed and arranged to insert into said first fitment outlet to close off said first fitment outlet and a second plug member constructed and arranged to insert into said second fitment outlet to close off said second fitment outlet.

6. The dispensing container of claim 5 wherein said closure fitment is constructed and arranged relative to first dispensing outlet to create a snap-in assembly with said first container by way of said first dispensing outlet.

7. The dispensing container of claim 6 wherein said threaded cap and said closing plug are each constructed and arranged for creating a snap-together subassembly constructions.

8. The dispensing container of claim 1 wherein said closure fitment includes a dispensing conduit connected to said second dispensing outlet.

9. The dispensing container of claim 8 wherein said dispensing conduit extends from said second dispensing outlet to said second fitment outlet.

10. The dispensing container of claim 1 wherein said closure fitment is constructed and arranged relative to first dispensing outlet to create a snap-in assembly with said first container by way of said first dispensing outlet.

11. The dispensing container of claim 1 wherein said threaded cap and said closing plug are each constructed and arranged for creating a snap-together subassembly construction.

12. The dispensing container of claim 1 wherein said first flowable product and said second flowable product are to be mixed at the time of dispensing in a pre-determined volumetric ratio of said first flowable product to said second flowable product, said closure fitment being constructed and arranged such that said first fitment outlet having a first flow area and said second fitment outlet having a second flow area, the flow area ratio of said first flow area to said second flow area corresponding to said predetermined volumetric ratio.

13. The dispensing container of claim 12 wherein said first container has a first capacity and said second container has a second capacity, said second capacity being at least equal to the quantity of said first capacity divided by said predetermined volumetric ratio.

14. The dispensing container of claim 13 wherein said first and second fitment outlets are constructed and arranged to establish a volumetric ratio between 2:1 and 5:1.

15. The dispensing container of claim 1 wherein said closure subassembly is constructed and arranged with clearance fits for said threaded cap to have relative rotary motion about said closing plug such that, in rotation, said threaded cap turns independently of said closing plug.

16. The dispensing container of claim 15 wherein said closure fitment includes a dispensing conduit connected to said second dispensing outlet.

17. The dispensing container of claim 16 wherein said dispensing conduit extends from said second dispensing outlet to said second fitment outlet.

18. The dispensing container of claim 15 wherein said closing plug includes a first plug member constructed and arranged to insert into said first fitment outlet to close off said first fitment outlet and a second plug member constructed and arranged to insert into said second fitment outlet to close off said second fitment outlet.

19. The dispensing container of claim 18 wherein said closure fitment is constructed and arranged relative to first dispensing outlet to create a snap-in assembly with said first container by way of said first dispensing outlet.

20. A dispensing container for two flowable products comprising:
a first container constructed and arranged for receipt of a first flowable product and including a first dispensing outlet, said first container defining a hollow interior;
a second container constructed and arranged for receipt of a second flowable product and being positioned within said hollow interior, said second container including a second dispensing outlet;
a closure fitment assembled to said first container and defining a first fitment outlet for dispensing said first flowable product and defining a second fitment outlet for dispensing said second flowable product; and
a closure subassembly threadedly engageable with said closure fitment for closing off said first and second fitment outlets, said closure subassembly including a closing plug and a threaded cap, said threaded cap capturing a portion of said closing plug so as to axially advance said closing plug with threaded engagement of said closure subassembly onto said closure fitment and so as to axially withdraw said closing plug with threaded disengagement of said closure subassembly from said closure fitment, said closing plug including a first plug member constructed and arranged to insert into said first fitment outlet to close off said first fitment outlet and a second plug member constructed and arranged to insert into said second fitment outlet to close off said second fitment outlet.

21. The dispensing container of claim 20 wherein said closure fitment includes a dispensing conduit connected to said second dispensing outlet.

22. The dispensing container of claim 21 wherein said dispensing conduit extends from said second dispensing outlet to said second fitment outlet.

23. The dispensing container of claim 22 wherein said closure fitment is constructed and arranged relative to first dispensing outlet to create a snap-in assembly with said first container by way of said first dispensing outlet.

24. The dispensing container of claim 23 wherein said threaded cap and said closing plug are each constructed and arranged for creating a snap-together subassembly constructions.

25. The dispensing container of claim 24 wherein said second container is a collapsible bag.
